(19) United States
(12) Patent Application Publication
(10) Pub. No.: US 2015/0098472 A1
(43) Pub. Date: Apr. 9, 2015

(54) Routing Packet From Edge Device to Home Network or From Home Network to Remote Access Network

(71) Applicants: Byung Kyu Choi, Roseville, CA (US); Mark W. Fidler, Granite Bay, CA (US)

(72) Inventors: Byung Kyu Choi, Roseville, CA (US); Mark W. Fidler, Granite Bay, CA (US)

(21) Appl. No.: 14/391,224

(22) PCT Filed: Jun. 29, 2012
(86) PCT No.: PCT/US2012/045010

§ 371 Date: Oct. 8, 2014

(51) Int. Cl. H04L 12/741

(52) U.S. Cl. CPC H04L 45/74
USPC 370/392

(57) ABSTRACT

A packet originating from, or destined for, a client device is routed according to a routing policy which redirects the packet to a home network of the client device, or to a remote access network on which the client device is present, by obtaining a route and constructing a multi-layer tunnel header, each layer of the multi-layer tunnel header corresponding to a respective node on the route.

### BACKGROUND

Networks allow communication of data between devices. For example client devices may connect to a server or to the Internet over a network. A local area network (LAN) is typically a network confined to a single building, or one or more floors of a building, and devices on a LAN may communicate with each other using a layer 2 protocol such as Ethernet. Campus area networks typically comprise a plurality of LANs which are connected together and may thus span several buildings, for example the buildings on a university campus. Enterprise networks are similar to campus area networks, but are deployed by enterprises and businesses.

In some cases a client device may be associated with a ‘home network’ which is a particular part of a network, such as an IP-subnet or a VLAN (Virtual Local Area Network).

### BRIEF DESCRIPTION OF THE DRAWINGS

Examples of the invention will now be described, by way of non-limiting example only, with reference to the accompanying drawings, in which:

FIG. 1 shows a network according to an example of the present disclosure;

FIG. 2 shows an example network structure in more detail and two possible redirection routes from an edge device to a home network;

FIG. 3 is a flow diagram showing a method of redirecting traffic according to an example of the present disclosure;

FIG. 4 shows an example of a multi-layer tunnel header and payload according to the present disclosure;

FIG. 5 shows another example of a multi-layer tunnel header and payload according to the present disclosure;

FIG. 6 is a flow diagram showing method for a network device handling a packet having a multi-layer tunnel header according to an example of the present disclosure;

FIG. 7A shows an example of an alternative multi-layer tunnel header structure and payload according to the present disclosure;

FIG. 7B shows an example of another multi-layer tunnel header structure and payload according to the present disclosure;

FIG. 8 is a flow diagram showing a method of redirecting traffic by a client device in a home network, according to another example of the present disclosure;

FIG. 9 is a schematic diagram showing an example of an edge device according to the present disclosure;

FIG. 10 is a schematic diagram showing an example of a server according to the present disclosure;

FIG. 11 is a schematic diagram showing an example of a network device for forwarding a packet having a multi-layer tunnel header according to the present disclosure; and

FIG. 12 is a schematic diagram showing an example of a network device for use in a home network according to the present disclosure.

### DETAILED DESCRIPTION

A Campus or Enterprise network may comprise a plurality of IP-subnets, each of which corresponds to a separate LAN. Further, one or more Virtual Local Area Networks (VLANs) may be set up in order to separate traffic belonging to different organizational departments. VLANs make it possible for a single switch or router to have more than one broadcast domain and also allow a broadcast domain to extend across several switches and/or routers.

A client device, such as a computer or a laptop, may be associated with a particular part of the network called the ‘home network’ A “home network” is a single broadcast domain, for instance it may be a VLAN (Virtual Local Area Network) or an IP subnet.

Client devices typically connect to the network through an edge device. An edge device is a device which is the client device's first point of contact with the network. For example, the edge device may be a wireless access point if the client device connects to the network wirelessly or a LAN (Local Area Network) switch if the client device connects to the network via a wired connection. The network may have a plurality of edge devices.

In one example, the network may be a campus network, for instance at a university. Typically students do not have a dedicated office, but move from one place to another depending upon their class schedule. Most of the students will carry their client device and connect wirelessly to the campus network via the nearest access point in whichever location they are currently at. Typically the wireless access points will connect to an existing wired campus network. This utilizes existing resources and is cheaper than deploying a separate network just for wireless users. As there are often tens of thousands of students and many different locations on a university campus, it is not unusual to have many thousands of access points.

Due to the university organization, students will typically be associated with a particular home network, such as their department network (e.g. the Chemistry Department or Engineering Department etc). The student will log into the wireless network from their client device, for instance by entering a user name and password. Traffic to and from the client device is then redirected so that it flows through the home network, regardless of the client device's current location. This makes it appear that the client device is on the home network and ensures that all resources on the home network are available to the client device (otherwise due to security policies, some resources may not be available). Re-direction of traffic via the home network may also help the client device to keep the same IP address, even when it roams between different access points.

While the above example relates to a campus network, the teachings of the present disclosure could also be applied to an enterprise network. Further, while the above examples relate to wireless networks, the principles of this disclosure and the concept of a ‘home network’ may also be applied to a client device which has a wired connection to a network. For example, a medical device such as a heart rate monitor in a hospital may have a wired connection to the hospital network. In that case the ‘home network’ for the wired device may be a server for that medical device, e.g. a heart rate monitor server; and the edge device may be a IAN switch at the edge of the hospital network.

The home network to which a client device belongs may be determined automatically or by a network administrator when the client device is first registered with the network. Typically the “home network” will be the network to which the client device is usually connected, or will correspond to a part of the organization to which a user of the client device belongs. In some cases, such as the heart rate monitor described above, the “home network” may be a pre-determined part of the network to which the client device needs to connect in order to carry out particular functions.

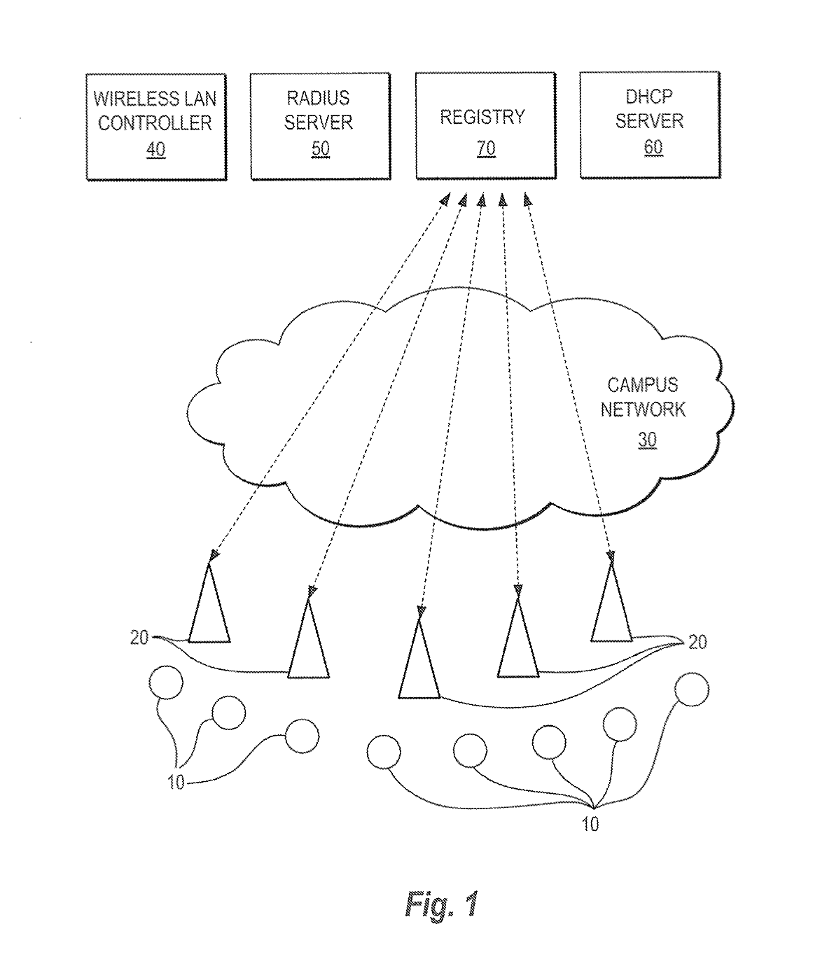

FIG. 1 shows a network 1 as an example in accordance with the present disclosure. There are a plurality of client devices 10 and edge devices 20. The edge devices 20 in this example are wireless access points (APs) and together with the client devices form a wireless local area network, for example using one of the 802.11 IEEE protocols.

Each client device 10 joins an access point 20. Typically each client device decides which access point to join based on proximity, the signal strength of the access point or other considerations. The access points 20 connect to the campus network 30 such that the client devices may access resources on the campus network 30 and/or connect to the Internet through a router of the campus network. The campus network 30 is typically a wired network and each access point 20 is typically connected to a switch or other node of the campus network by a wired connection.

In the example of FIG. 1, the network has a WLAN Controller 40, a RADIUS Server 50, a DHCP Server 60 and a Registry 70. The WLAN Controller manages the access points. The RADIUS Server performs security checks and controls access to the network. The DHCP Server provides an IP address to each client device joining the network. The Registry 70 stores information mapping each client device for user account) to a particular home network. The Registry may also store routes from each access point to each home network as will be explained later. The Registry may be implemented by one or more servers and associated storage resources. While the WLAN Controller, RADIUS Server, DHCP Server and Registry are illustrated here as separate devices it is to be understood that some or all of them may be combined into one device or server. For example, the Registry may be incorporated into the WLAN Controller.

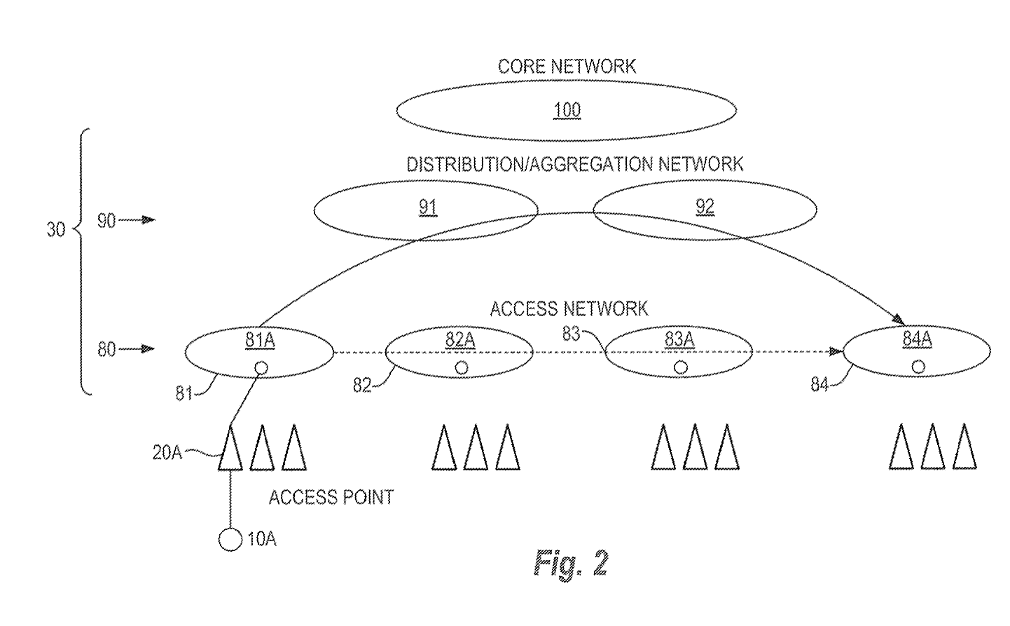

Referring now to FIG. 2, an example network structure is shown in more detail. As in FIG. 1, there is a plurality of access points 20 and a wired network 30. The network 30 has a three layer structure including a core network layer 100, a distribution or aggregation layer 90 and an access layer 80. The access layer 80 connects to user devices and/or access points and is a first point of access to the wired network. The access layer comprises a plurality of network sections (e.g. VLANs) 81, 82, 83, 84. In the interest of clarity only a single access switch 81A, 82A,83A, 84A is shown in each of the network sections 81-84 in FIG. 2, but it is to be understood that each section may comprise several switches or other network devices. The switch to which an access point connects is typically pre-determined by the network administrator and/or network wiring.

The core layer network 100 is a backbone layer which typically comprises high power switches and routers and facilitates access to the internet and/or connection to other networks. The distribution or aggregation layer 90 is an intermediate layer connecting the core and access layers, it may for example comprise layer 2 or layer 3 switches or routers 91, 92. It should be noted that the three layer structure shown here is just an example and the teachings of the present disclosure may be implemented on networks having more or less layers. For example, some enterprises and campuses have a flatter structure with less than three layers.

If the client device and edge device (e.g, access point) belong to different home networks then traffic from the client device should be redirected to the home network before being forwarded to its final destination. The same applies if the client device has a wired connection to a network (in which case the edge device may be a switch which the client device is connected to).

Traffic re-direction may be achieved by a technique known as tunneling. In tunneling the packet which is to be sent through the tunnel is treated as a payload and encapsulated by adding a tunneling header. Examples of tunneling protocols include GRE (Generic Routing Encapsulation), PPPT, L2PT etc. The tunnel is between an ingress node (the edge device) and an egress node (a node of the home network). The payload packet is forwarded from the ingress node to the egress node according to the tunneling header and then de-capsulated at the egress node and forwarded on to its original destination. In this way re-direction is achieved and the client device appears to be present on the home network, even if it is in fact connected to an edge device in a remote part of the network.

In FIG. 2, client device 10A is not directly connected to its home network 84, but rather is connected to a “remote access network” 81 via edge device 20A. Put another way, the client device 10A and edge device 20A belong to different home networks: the client device belongs to VLAN 84, while the edge device belongs to VLAN 81. As mentioned above, the ‘home network’ of the client device is stored in a database managed by the Registry. Meanwhile, the edge device knows that it belongs to VLAN 81 through its own configuration data which is typically stored in a memory of the edge device.

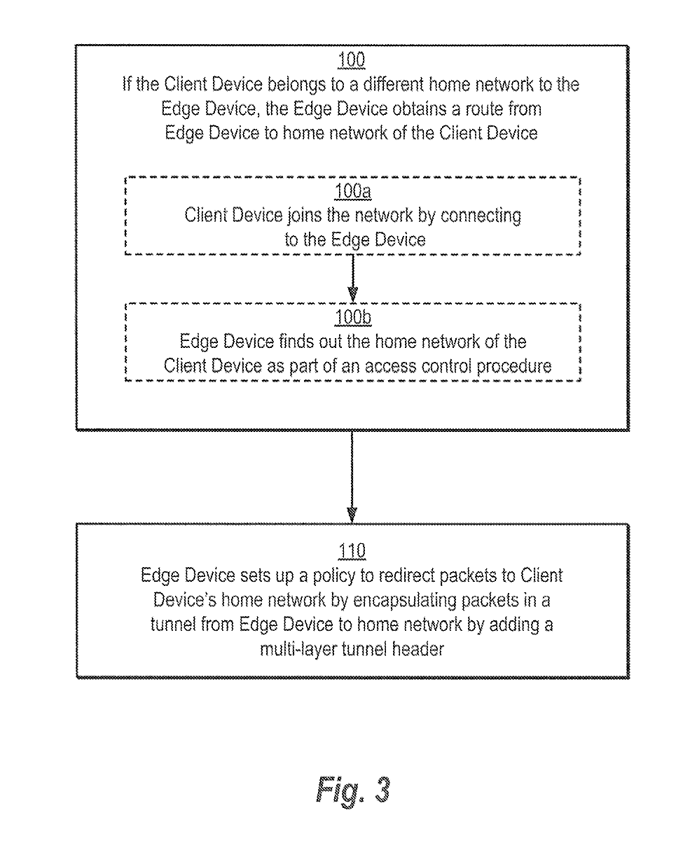

As the client device 10A is not on its home network, the edge device constructs a tunnel to redirect traffic from the client device to the client device's home network. A method of re-directing traffic in a network will now be described in more detail with reference to FIG. 3.

At block 100 if the client device belongs to a different home network to the edge device, then the edge device obtains a route from the edge device to the home network of the client device. At block 110 the edge devices uses the obtained route to set up a routing policy to route packets received from the client device to the client device's home network. The policy may require redirecting the packet through a tunnel to a node of the home network. Several examples will now be explained in more detail. There are various methods by which the edge device may determine that the client device belongs to a different home network. In one example, the edge device is informed of the home network of the client device by a remote server (e.g. Registry 70). In one example, shown in dotted lines in FIG. 3, the edge device finds out the home network of the client device as part of an access control procedure. At block 100a the client device joins the network by connecting to the edge device (e.g. by sending a join request in a wireless network, or by physical connection in a wired network). At block 100b the home network of the client device is determined by the edge device as part of an access control procedure. For example, to the edge device may send a join request to a RADIUS server 50 as part of the access control. The RADIUS server responds by challenging the client device for security credentials (e.g. user name and password). The user responds with the security credentials. The RADIUS server receives the security credentials, authenticates and authorizes the network access by the client device if the security credentials are correct. These communications pass between the client device and the RADIUS server via the edge device.

While the above example of access control requires input from the user, access control may alternatively be handled in a transparent fashion (i.e. without requiring user input). For instance, if the client device has already joined the WLAN and roams to a different access point, then the original access point or the WLAN Controller may communicate the security credentials on behalf of the user. In another example of access control, the WLAN Controller, or another device, compares the MAC address of the client device with a list of MAC addresses of approved devices which have permission to access the network.

Regardless of which access control procedure is used the Registry 70 checks the home network of the client device as part of the procedure. If the home network of the client device belongs to a different home network to the edge device which it has joined, this is communicated to the edge device at block 100b, either together with the access control results or in a separate message.

The Registry stores or has access to a database mapping each user or client device to a home network. See for example table 1.

TABLE 1

| Client Device | Home Network |
|---|---|
| Client Device 1 | Home Network 1 |
| Client Device 2 | Home Network 1 |
| Client Device 3 | Home Network 2 |

The client device may be identified by an identifier of the client device itself (e.g. the MAC address) or by an identifier of the user of the client device (e.g. the username which the user of the client device uses to log into the network).

The home network to which a client device belongs may have been set by the network administrator and saved in the Registry 70 when the client device was first registered for use on the network. For example, at the same time the client device user registered their security credentials (e.g. user name and password) with the RADIUS server 50.

In another example, the client device may be assigned the same home network as the access point which it initially joins and this information may be saved on the Registry. Subsequently if the client device roams to another access point, the another access point retrieves the identity of the client device's home network from the Registry.

If the client device is on the same home network as the AP then no traffic re-direction is necessary. However, if the client device and the edge device belong to different home networks then the edge device sets up a traffic redirection policy, and in order to do this it obtains a route from the edge device to a home network of the client device.

The route may be sent to the edge device by the Registry together with the information about the home network of the client device, or in response to a separate request sent by the edge device. Table 2 shows an example of the contents of a database providing route information from edge devices to home networks.

TABLE 2

| Edge Device | Home Network | Route |
|---|---|---|
| Edge Device 1 | Home Network 1 | Route 1 |
| Edge Device 1 | Home Network 2 | Route 2 |
| Edge Device 2 | Home Network 1 | Route 3 |
| Edge Device 2 | Home Network 2 | Route 4 |
| Edge Device 3 | Home Network 1 | Route 5 |
| Edge Device 4 | Home Network 2 | Route 6 |

The route stored in the Registry may be set by the network administrator and may be based on any of the shortest path, quality of service considerations, load balancing and security considerations or a combination thereof. The routes may be set or updated automatically or semi-automatically by various programs on the Registry for gathering network data and topology and determining appropriate routes. Typically the route may comprise a plurality of switches or routers on a path from the edge device to a node of the home network.

The edge device uses the obtained route to generate a routing policy for packets received from the client device (block 110 of FIG. 3). The routing policy specifies that packets from the client device should be encapsulated in a tunnel to the home network according to the route obtained from the Registry. The routing policy may be stored in a routing table in a memory of the edge device.

When the edge device receives packets from the client device, the edge device implements the routing policy by constructing a tunnel header having a plurality of layers (a ‘multi-layer’ tunneling header). Each layer of the tunneling header corresponds to a hop on the route from the edge device to the home network of the client device.

As the entire route is specified in the multi-layer tunnel header, it is not necessary for each switch or node on the route to store routing entries for each possible tunnel header in order to process and forward the encapsulated packet. This reduces the load on each intermediate node on the route. Furthermore, in conventional (single layer header) tunneling, the number of possible tunnel headers in a campus network is equal to the number of edge devices multiplied by the number of home networks. For example in a campus network with 100 home networks and 2000 access points the number of possible tunnel headers is 200,000. For optimum performance the tunnel routing table may be a hardware table utilizing expensive memory. Therefore, the cost saving by using a multi-layer tunnel header can be quite significant.

In this example the necessary route is obtained from an external source (e.g. the Registry 70), therefore the edge device need not store a route from itself to each possible home network. Further, storing the routes centrally in the Registry may facilitate efficient updating of the routes if they change. The Registry may comprise a single server which stores or has access to both the association between each client device and home network, and routes from each edge device to each home network. However, in other arrangements the Registry may comprise plural servers. It would for example be possible to have the association between client device and home network handled by a first server and the above mentioned routes handled by a second server.

FIG. 2 illustrates two example routes from the edge device 20A to a node of the home network 84. A first route is shown by the dotted line is via the access layer of the network. The route comprises network devices 81A, 82A, 83A and 84A.

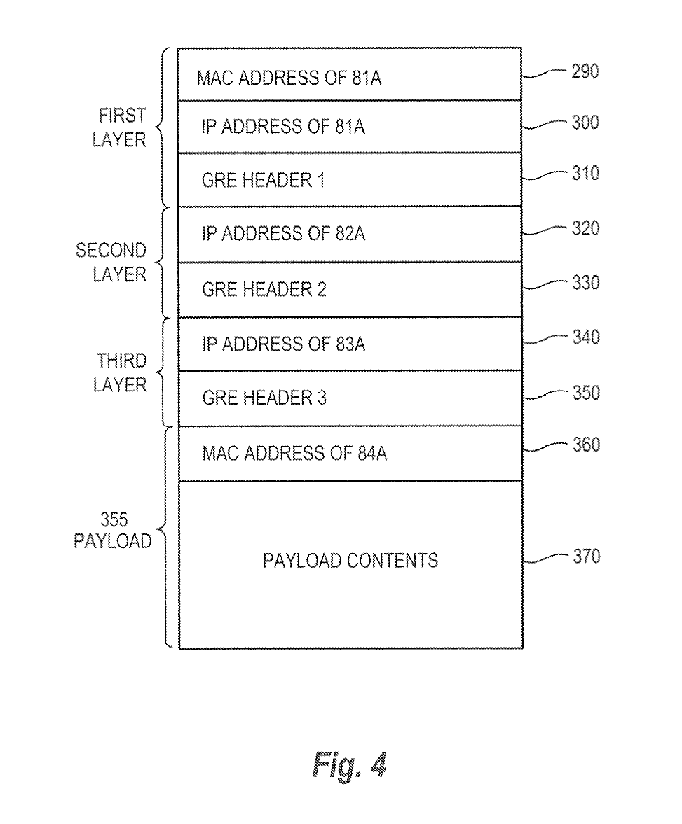

FIG. 4 shows an example of a multi-layer tunnel header for implementing the first route described above. The first layer comprises the MAC address of the network device 81A, IP address 300 of network device 81A and a first GRE header 310. The second layer comprises the IP address 320 of a network device 82A and a second GRE header 330. The third layer comprises the IP address 340 of a network device 83A and a third GRE header 350. The payload 355 comprises the MAC address 360 of a network device 84A in the home network 84 and the contents of the original packet from the client device.

The multi-layer tunnel header is constructed on the basis of the route specified by the Registry 70. Each layer of the header thus specifies a destination which is a network device having the ability to recognize and process multi-layer tunneling headers. Such network devices may be referred to as “Onion Tunneling” network devices as the multi-layer tunnel header is like an onion in that it has plural layers.

In the above example each layer of the multi-layer tunnel header includes a GRE header, i.e. GRE is used as the tunneling protocol. However, other tunneling protocols could be used instead. Further, it is not necessary for each layer of the header to use the same tunneling protocol, it would for example be possible to have a multi-layer tunnel header which utilized several different tunneling protocols (e.g. a different tunneling protocol in each layer).

Each layer of multi-layer tunnel header, except the last one, may include a flag indicating that the tunnel header has multiple layers. For example, if a GRE header is used the multi-layer nature of the header may indicated by setting the control bit “s” or by setting one of the optional bits available in the GRE header protocol. An Onion Tunneling (OT) network device receiving a packet with a header marked in this way is thus able to recognize it as a multi-layer tunnel header and may be configured to process the packet accordingly.

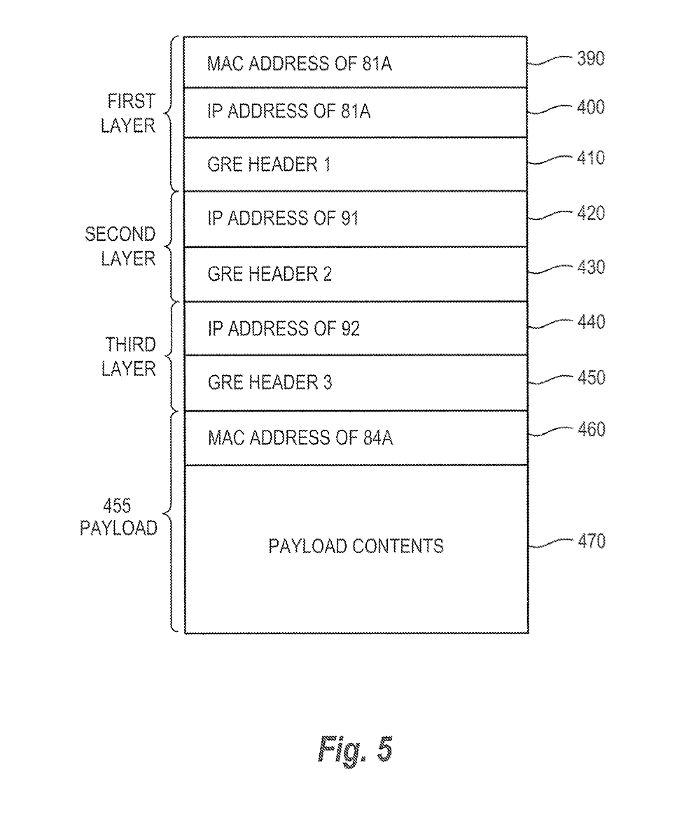

The above described route (shown by the dotted line in FIG. 2) is along the access layer and may be the shortest path from the remote access network to the home network. A second route shown by the solid line in FIG. 2 traverses the distribution/aggregation layer of the network and passes through network devices 81A, 91, 92 and 84A. A multi-layer tunnel header corresponding to the second route is shown in FIG. 5. It has layers 400-470 similar to those described in FIG. 4, but with the second and third layers specifying the IP address of network devices 91 and 92 in the aggregation layer.

A route traversing the distribution/aggregation layer may for example be specified by the Registry if one or more sub-nets on the shortest path in the access layer do not support multi-layer tunnel headers. In other examples it would be possible for the routing to be via the core network 100. However, in the two examples shown in FIG. 2, the routing is not via the core network and therefore the load on the core network is relieved. Further, the tunneling overhead may be reduced compared to a route which traverses the core layer.

Once the multilayer tunnel header has been constructed, the edge device forwards the encapsulated packet towards the destination specified by the first (outermost) layer of the multi-layer tunnel header which is a hop on the route to the home network. The encapsulated packet may be forwarded directly to the destination specified by the outermost layer of the tunnel header or forwarded indirectly via one or more intermediate devices not specified in the header.

An intermediate device may for example be a non-OT network device. The intermediate device forwards the encapsulated packet by regular routing or bridging (i.e. according to the destination address in the outermost layer of the multi-layer tunnel header and without stripping a layer off the multi-layer tunnel header).

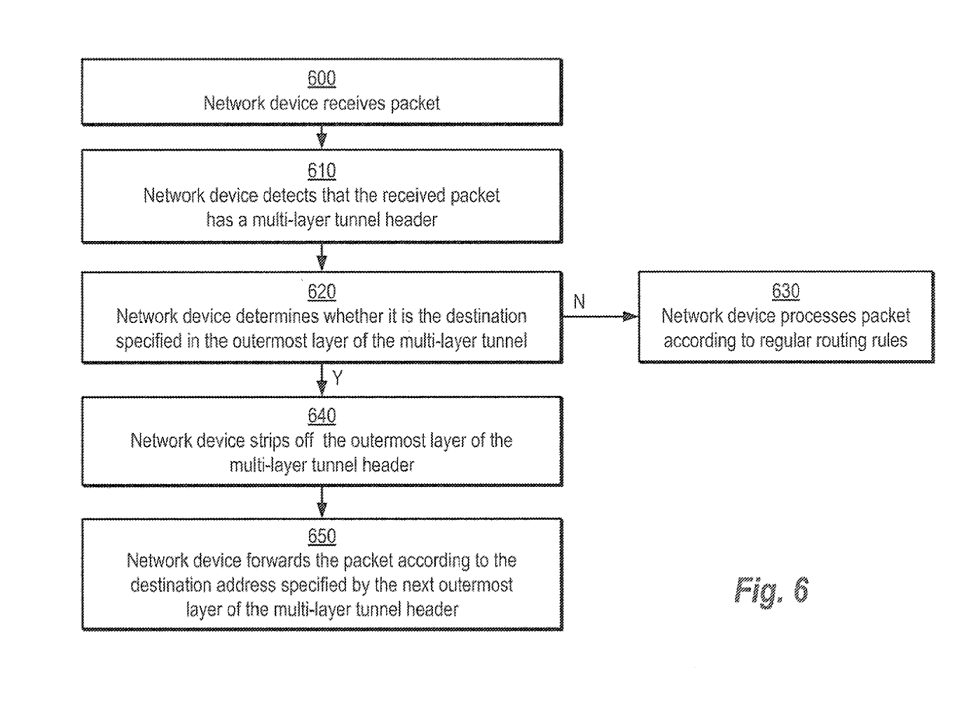

When an OT network device (such as a switch, router etc) receives an encapsulated packet having a multi-layer tunnel header, it proceeds according to the flow diagram in FIG. 6. At 600 the OT network device receives a packet. At 610 the OT network device detects that the received packet has a multi-layer tunnel header. At 620 the OT network device reads the outermost layer of the multi-layer tunnel header and determines whether or not it is the intended destination. If the address of the OT network device does not match the address in the outermost layer of the tunnel header, then at 630 the OT network device handles the packet according to regular routing rules (i.e. dropping of forwarding the packet depending on the contents of the network device's routing table). If the OT network device has an address matching the address specified by the outermost layer of the multi-layer tunnel (e.g. 300 in FIG. 4), then at 640 the OT network device strips off the outermost layer of the multi-layer tunnel header. At 650 the OT network device then forwards the packet according to the destination address specified by the next layer of the multi-layer tunnel header (e.g. 320 in FIG. 4). This forwarding is done by regular bridging and routing algorithms as if the packet has originated in the OT network device itself.

This process continues and the packet is forwarded from network device to network device until it arrives at the OT network device specified by the last layer of the multi-layer tunnel header (e.g. 340 in FIG. 4). This OT network device strips off the last layer of the multi-layer tunnel header and then forwards the original payload (e.g. 370 in FIG. 4.

FIGS. 4 to 6 describe a method in which the nodes specified in the multi-layer header must be able to recognize and process multi-layer tunnel headers in a particular manner. Specifically, each node is an Onion Switch or an Onion Router able to recognize the multi-layer header as such according to a flag in the header, strip off the outermost layer and then lookup the IP Destination address in the next layer, add the appropriate layer 2 header and forward to the correct port. However, with a small modification to the structure of the multi-layer tunnel header, the method of the present disclosure may be applied to a network with conventional network devices, without the need for special OT switches or routers on the route between the edge device and the home network.

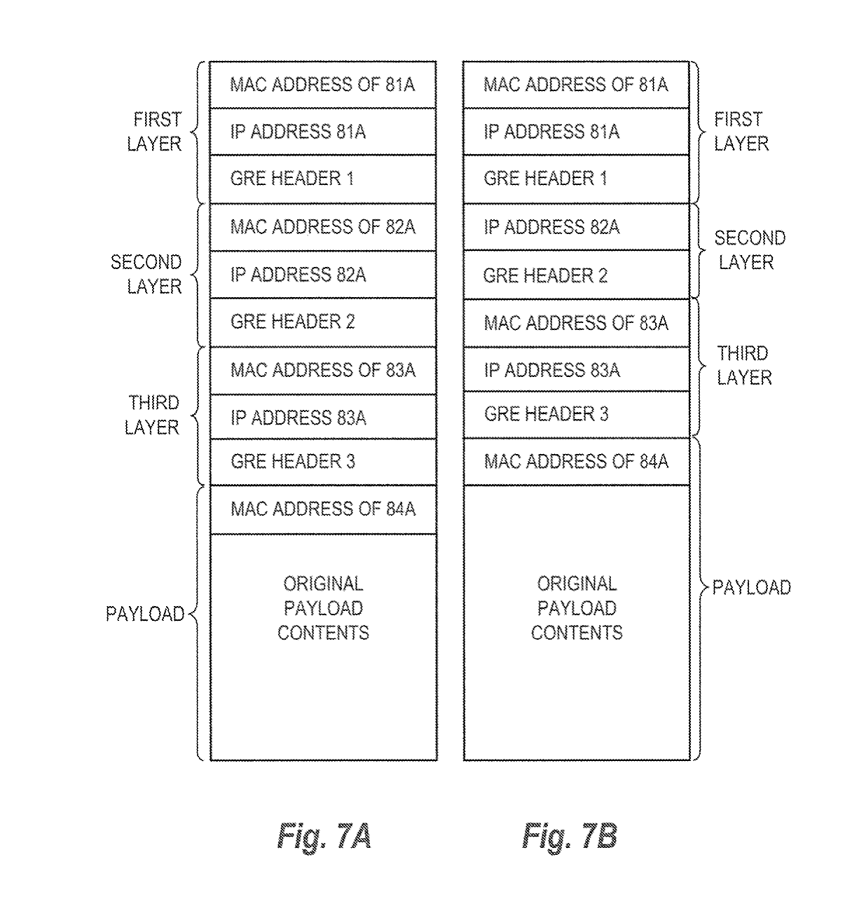

FIG. 7A illustrates an alternative multi-layer tunnel header that may be processed by a conventional network device which is capable of handling single layer tunnel headers, but which is not specifically configured to handle multi-layer tunnel headers (i.e. a conventional network device, rather than an OT network device). As in the example of FIG. 4, the route specified by the header of FIG. 7A is via network devices 81A, 82A, 83A and 84A. The multi-layer header comprises three layers and a payload and the contents are similar to those shown in FIG. 4. However, a MAC address is included in each layer of the multi-layer tunnel header. That way when a conventional network device capable of handling a single layer tunnel header receives the packet, it strips off the outermost layer and then is able to forward the according to the MAC address in the next layer (which it perceives as the payload). The network device in this case does not realize that the packet has a multi-layer header and simply sees a packet with a single layer tunnel header and a payload. The network device thus does not need to be configured to lookup an IP address from the next layer and add a corresponding MAC address in order to forward the packet to the next hop, as the MAC address is already present in the next layer (having been specified in the route provided by the Registry). However, if this approach with a MAC address in each layer is used, then the route specified by the Registry should be a complete route listing each hop on the path from the edge device to the home network (i.e. there should not be any intermediate devices between the hops as the MAC address in each layer should lead directly to the next node).

FIG. 7B illustrates a hybrid approach which may be used where some of the nodes on the route specified in the multi-layer header are OT devices and others are conventional network devices. The multi-layer header is similar to that shown in FIG. 4, except that in this example the network device 82A is not capable of recognizing multi-layer tunnel headers. Accordingly, the third layer (which will be processed by the network device 82A) comprises a MAC destination address as well as an IP destination address. The network device 82A is thus able to appropriately forward the packet to the destination specified in the next layer without implementing a special handling process for the multi-layer tunnel header.

In both FIGS. 7A and 7B the ‘protocol type’ field of the GRE headers will generally indicate ‘IP’. The IP headers will have a field of ‘protocol number’ which indicates the type of payload encapsulated by the IP header. The ‘protocol number’ field of the IP headers in the first and second layers may be set to “47” indicating that the payload of the IP header is another GRE packet (i.e. that the next layer is another GRE packet). The IP header in the third layer may have the ‘protocol number’ field set to UDP, TCP or any other depending upon the destination application of the IP packet.

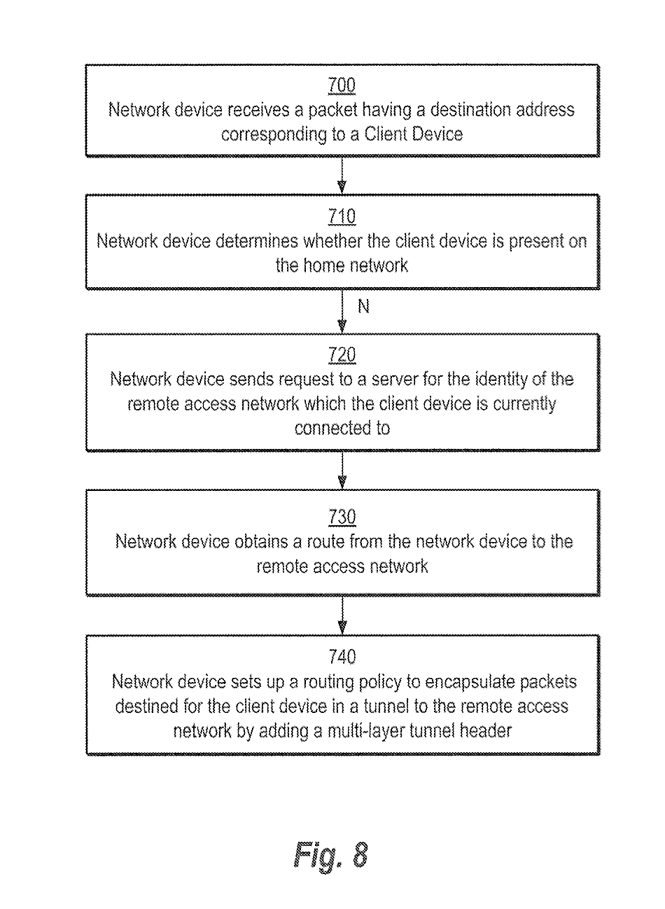

FIG. 8 is a flow diagram showing a reverse tunneling performed by a network device in the client device's home network when it receives a packet destined for the client device. For example the packet may be sent by another device on the client device's home network, by a server of another subnet, or may be a packet received from the Internet.

At 700 the network device receives a packet having a destination address of the client device.

At 710 the network device determines whether the client device is present on the home network (e.g. joined to an AP of the home network or physically connected by a wired connection to an edge device of the home network). For example the network device may keep a list of devices in its home network in a routing table.

If the client device is present on the home network then the network device may forward the packet as normal. However, if the network device determines that the client device is not currently on its home network then at 720 the network device sends a request to the Registry 70 (or another server) to find the location of the client device. The Registry may maintain a database indicating which remote access network each client device is currently connected to.

At 730 the network device obtains a route from the network device to the remote access network of the client device. The Registry may communicate the route from the network device to the remote access network of the client device in response to the request for the client device's location or in response to a separate request. Alternatively the network device may obtain the route from another server.

At 740 the network device sets up a routing policy to encapsulate packets destined for the client device in a multi-layer tunnel to the remote access network. Each layer of the multi-layer tunnel corresponds to a hop on the route from the home network to the remote access network. The details of forwarding the encapsulated packet via the tunnel to the remote access network are the same as those described in FIG. 6 but in the reverse direction.

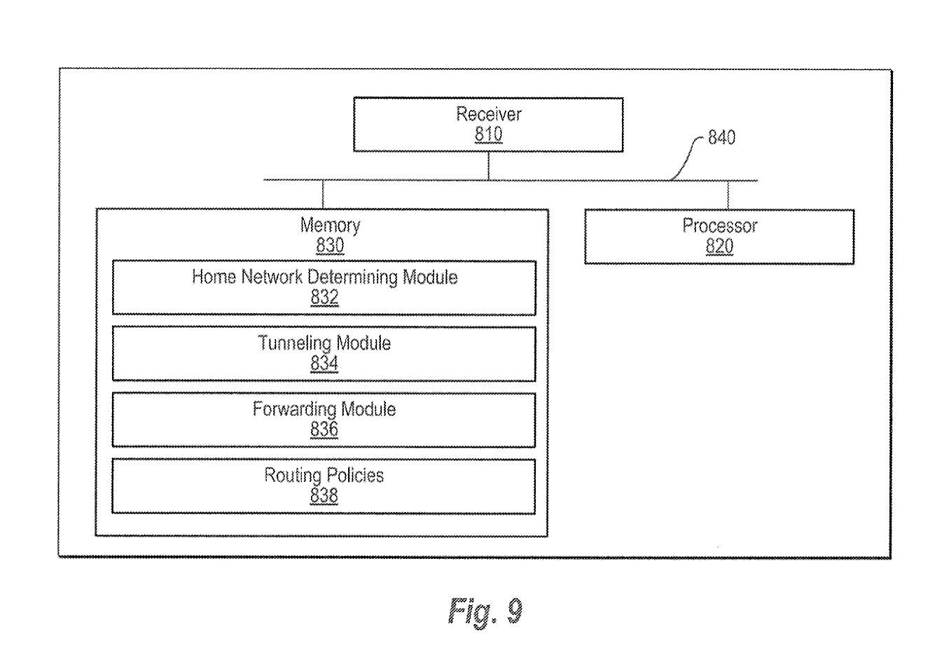

FIG. 9 is a schematic diagram showing an edge device 800 according to the present disclosure. The edge device may for example be an Ethernet switch or a wireless access point. The edge device has a receiver 810 for receiving packets from a client device. In the case of an access point the receiver may be a transceiver for sending and receiving wireless signals, in the case of an Ethernet switch the receiver may be a port of the switch for receiving a wired connection to a client device. The edge device further comprises a processor 820, such as a CPU, and a memory 830 which may store configuration data, firmware and/or various software modules which are executable by the processor. The various components of the edge device may be connected by an internal bus 840 or similar. In this example, the memory stores a home network determining module 832 for obtaining a route from the edge device to a home network of a client device connected (wired or wirelessly) to the edge device and setting up a routing policy, a tunneling module 834 for constructing a tunnel and a forwarding module 836 for forwarding an encapsulated packet from the edge device to a wired network. Each of these modules comprises machine readable instructions which are executable by the processor and which may perform the functions described in the method shown in FIG. 3. Alternatively some or all of the modules may be implemented by dedicated hardware such as an ASIC or other logic circuitry. The memory 830 further stores one or more routing policies 838 for instance specifying a routing policy for packets received from a particular client device. While for simplicity only a single processor and memory are shown in FIG. 9 and described above it is to be understood that there may be a plurality of memories and processors and the above modules and data may be distributed between them.

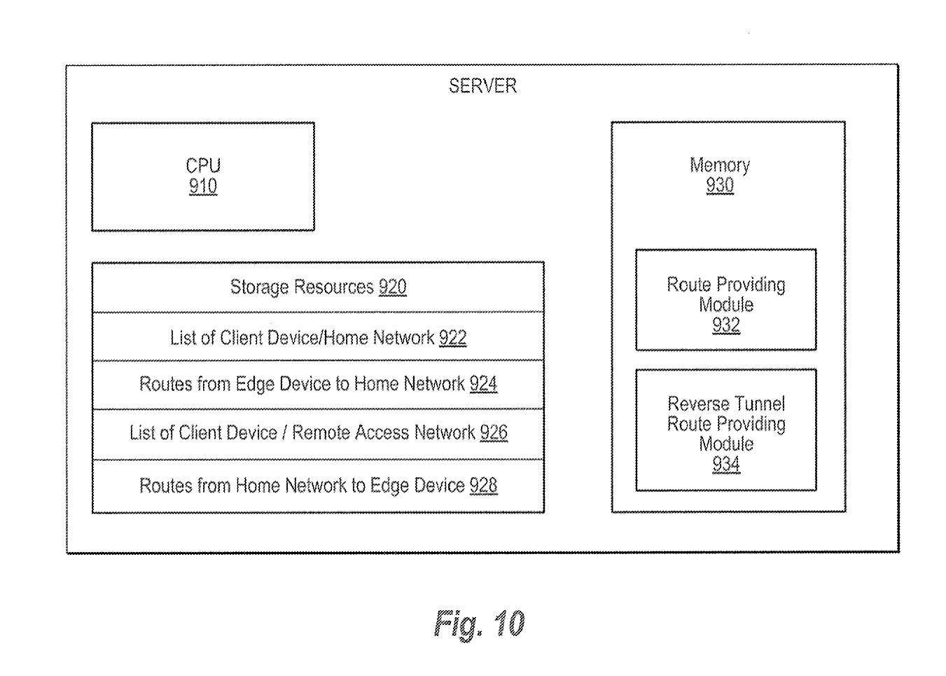

FIG. 10 is a schematic diagram showing an example of a Registry. The Registry may for example be a server and comprises or has access to storage resources 920 such as one or more non-transitory computer readable storage medium 920 (e.g. hard disk, storage array, optical or magnetic data storage etc) which stores a list 922 mapping client devices to the home networks to which they belong. The storage resources 920 further stores routes 924 from each edge device in a campus or enterprise network to each home network in the campus or enterprise network. The routes may comprise multiple hops. In one example the routes comprise the IP address of each hop, while in another example the routes comprise both the IP and MAC addresses of each hop. The Registry further comprises a processor 910 and a memory 930 storing a route providing module 932. The route providing module comprises machine readable instructions executable by the processor 910 to send the identity of a home network associated with a client device, and/or a route from an edge device to a home network, in response to a request from an edge device, wireless controller or the like. The storage resources 920 may also store a list 926 mapping client devices to the remote access networks which they are currently joined to and routes 928 from each home network to each edge device in the campus or enterprise network. The memory 930 may further store a reverse tunnel route providing module 934 to provide a route from a network device of a home network to an edge device of a remote access network which a client is currently joined to, in response to a request from the network device. While in the illustrated example the Registry comprises one server, the Registry may comprise several servers or be distributed over a plurality of devices. For instance the association between each client device and a home network may be stored on a separate device to the routes from each edge device to each home network. Likewise the information listing the remote access network which a client device is currently joined to may be stored on the same or a separate device, as may the reverse tunnel routing information.

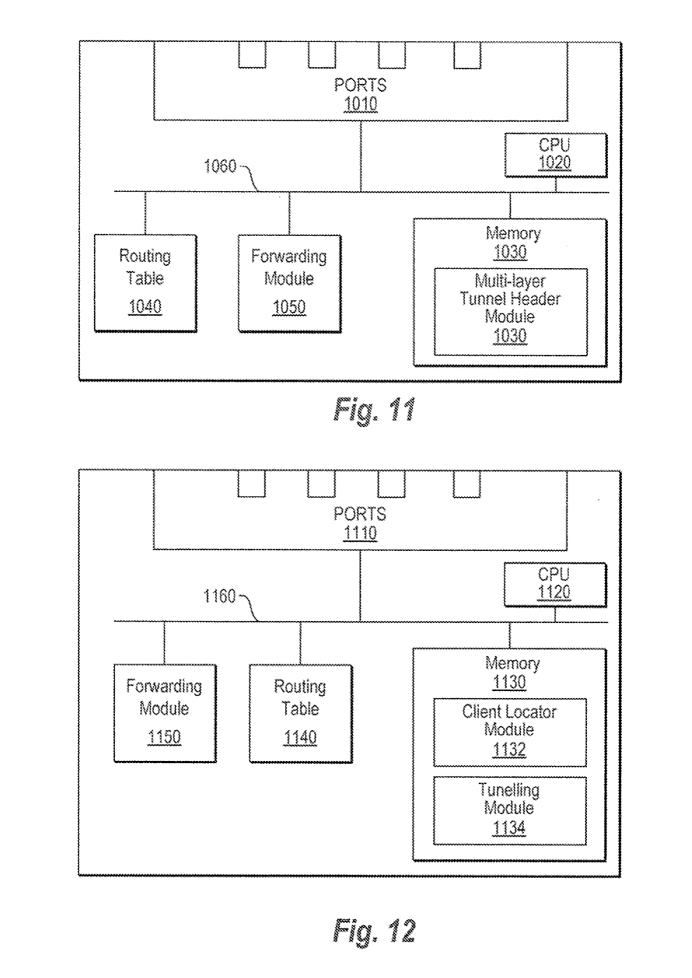

FIG. 11 is a schematic diagram showing an Onion Tunneling device (e.g. switch or router) according to one example. The OT device comprises a plurality of ports 1010 for receiving and sending data over a wired connection, a CPU 1020, a memory 1030, a routing table 1040 and forwarding module 1050 joined by an internal bus 1060 or similar. The memory 1030 stores a multi-layer tunnel header module 1032 which comprises machine readable instructions executable by the CPU 1020 to detect that an incoming packet received by one of the ports has a multi-layer tunnel header. This may be detected from a flag in the tunnel header. The instructions may be executed by the CPU to carry out the processes described in blocks 610 to 640 of FIG. 6, for example stripping the outermost layer of the module-layer tunnel header. The packet may then be forwarded by the forwarding ASIC 1050 in combination with the routing table 1040 which may for example be a TCAM. In this example the forwarding module is an ASIC, but in other examples the forwarding module may be implemented by the CPU in combination with machine readable instructions for routing and access to the routing table. Further, while in this example the multi-layer tunnel module is stored in memory and executable by the CPU, in other examples it may be implemented by other hardware logic circuitry.

FIG. 12 is a schematic diagram showing a network device for use in a home network according to the present disclosure. The network device may for example be a switch, router or server. The network device has a receiving module 1110 comprising a one or more ports for receiving packets via a wired connection. The network device further comprises a processor 1120, a memory 1130 storing machine readable instructions executable by the processor, a forwarding module 1150 and a routing table 1140 9 (e.g. a TCAM). The various components of the network device may be connected by an internal bus 1160 or similar. When the network device receives an incoming packet the CPU 1120 examines the packet to determine where the packet should be forwarded to (e.g. by reading the destination address and checking the routing table 1140 and/or another memory storing routing policies). If the destination is a client device belonging to the same home network as the network device, but the network device determines that the client device is not present on the home network (for instance because it is not present in the routing table, or because it is stored in memory in a list of devices roaming outside the home network), then the processor 1120 executes client locator module 1132 stored in the memory 1130. Client locator module 1132 sends a request to a remote server (e.g. Registry 70) for the current location of the client device and/or a route from the network device to an edge device of a remote access network which the client device is joined to. Upon receiving a route to the edge device of the remote access network, the processor may set up a routing policy to encapsulate packets destined for the client device in a tunnel to the remote access network by appending a multi-layer tunnel header with each layer of the header corresponding to a hop specified in the route obtained from the remote server. Further the processor may execute a tunneling module 1134, stored in the memory, to append a multi-layered tunnel header to the packet so that it may be routed to the remote access network. The forwarding module in combination with the routing table and then forwards the packet out of an appropriate port 1110 towards the destination specified in the outermost layer of the multi-layer tunnel header. Thus it can be seen that the network device of FIG. 12 is capable of implementing the method of FIG. 8. The modules discussed above may be implemented as machine readable instructions stored in memory and executable by a processor, or as hardware logic (e.g. an ASIC of FPGA) or a combination thereof. All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A method of redirecting a packet to a home network associated with a client device; the method comprising:
if the client device belongs to a different home network from the edge device, the edge device obtaining a route from the edge device to the home network and setting up a routing policy for a packet received from the client device; wherein the routing policy comprises encapsulating a packet received from the client device in a tunnel to the home network by adding a multi-layer tunnel header to the packet; each layer of the multi-layer tunnel header corresponding to a respective node on the route from the edge device to the home network.

2. The method of claim 1 wherein the edge device obtains information relating to the home network of the client device as part of an access control process.

3. The method of claim 1 wherein the edge device obtains the route from the edge device to the home network associated with the client device from a server storing routes from edge devices to home networks.

4. The method of claim 1 wherein the packet received from the client device is a layer 2 packet and wherein the edge device encapsulates said layer 2 packet in a multi-layer tunnel header, each layer of said multi-layer tunnel header comprising a layer 3 destination address.

5. The method of claim 1 wherein a flag is inserted in the tunnel header to indicate that the header is a multi-layer tunnel header.

6. The method of claim 1 wherein the route from the edge device to the home network is determined based at least partially on security, QOS or load balancing requirements.

7. An edge device comprising:
a receiver to receive a packet from a client device;
a home network determining module to determine whether the client device and the edge device belong to the same home network and if the client device and edge device do not belong to the same home network then obtain a route from the edge device to the home network;
a tunneling module to encapsulate a packet received from the client device by the receiver in a tunnel to the home network of the client device by adding a multi-layer tunnel header to the packet; said multi-layer tunnel header having a plurality of layers, each layer corresponding to a respective node on said route obtained by the home network determining module;
a forwarding module to forward the encapsulated packet towards the destination specified in an outermost layer of the multi-layer tunnel header.

8. The edge device of claim 7 wherein the edge device is a wireless access point.

9. The edge device of claim 7 wherein the home network determining module is to obtain information relating to the route from the edge device to the home network of the client device by sending a request for said information to a server.

10. The edge device of claim 7 wherein the packet is a layer 2 packet and wherein the edge device is to encapsulate the layer 2 packet using MAC-in-IP encapsulation.

11. The edge device of claim 7 wherein each layer of the multi-layer header comprises both a layer 3 and layer 2 destination address.

12. A registry comprising a processor having access to a non-transitory computer readable storage medium storing routes from each edge device in a network to each home network and a memory storing machine readable instructions executable by the processor to send information relating to a route from an edge device to a home network in response to a request from the edge device.

13. The registry of claim 12 wherein the registry further stores a list of client devices and a home network for each client device and machine readable instructions to forward the identity of the home network of a client device in response to a request.

14. A campus or enterprise network comprising the edge device of claim 7 and the registry of claim 12.

15. A network device comprising:
a receiver to receive a packet having a destination address corresponding to a client device;
a client device locator module to determine whether said client device is currently on the home network of the network device and if the client device is currently on a remote access network then obtain a route from the network device to the remote access network;
a tunneling module to encapsulate a packet having a destination address corresponding to the client device in a tunnel to the remote access network by adding a multi-layer tunnel header to the packet; said multi-layer tunnel header having a plurality of layers, each layer corresponding to a respective node on said route obtained by the client device locator module;
a forwarding module to forward the encapsulated packet towards the destination specified in the outermost layer of the multi-layer tunnel header.
